(19) United States
(12) Patent Application Publication
(10) Pub. No.: US 2009/0193153 A1
(43) Pub. Date: Jul. 30, 2009

(54) MTP-capable USB device and methods for use therewith

(76) Inventor: William N. Thanos, Scotts Valley, CA (US)

Correspondence Address: BRINKS HOFER GILSON & LIONE/SanDisk, P.O. BOX 10395, CHICAGO, IL, 60610, US

(21) Appl. No.: 12/005,547

(22) Filed: Dec. 26, 2007

(51) Int. Cl. G06F 3/00; G06F 1/04; G06F 12/08

(52) U.S. Cl. 710/11; 713/600; 711/103; 710/100; 710/14; 711/E12.019

(57) ABSTRACT

An MTP-capable USB device and methods for use therewith are disclosed. The USB device is provided with circuitry operative to communicate with a host device using a media transfer protocol and receive a command from the host device to play content stored in the memory of the USB device. In one embodiment, the USB device is free of a user input device for providing a command to the circuitry to play content stored in the memory. In another embodiment, the USB device is free of a display device. In yet another embodiment, the USB device comprises a housing comprising a USB Flash drive form factor. Other embodiments are provided, and each of these embodiments can be used alone or in combination with one another.

### BACKGROUND

With the growing popularity of digital media, some traditional products, such as car stereos and game boxes, now have (or will shortly have) a Universal Serial Bus (USB) port to allow the products to play digital media stored on a device connected to the USB port. A difficulty arises, however, when the digital content is protected by a digital rights management (DRM) mechanism, as the rights to play DRM-protected content are often tied to the portable digital media player that stores the content. To address this problem, Microsoft has introduced a PlaysFromDevice™ specification, which allows certified products to play DRM-protected content from a portable digital media player connected to the product's USB port. This allows the user to listen to DRM-protected content provided by a subscription service, such as Rhapsody™, Yahoo™, and Napster™, either on the portable digital media player storing the content or on a product with PlaysFromDevice™ capability connected to the portable digital media player. When the portable digital media player is used in standalone operation, a user selects stored content for playback using navigation controls and a display device on the portable digital media player, and the portable digital media player plays the selected content via an output device in the player (e.g., for audio content, an audio jack or built-in speaker). However, when the portable digital media player is connected to the product's USB port, controls on the product are used to navigate and select content stored in the portable digital media player, and the selected content is provided to the product and rendered through its output device. For example, with a car stereo with PlaysFromDevice™ capability, a user would select a song for playback using the car stereo's knobs and buttons, and the selected song would play through the car stereo's speakers.

### SUMMARY

The present invention is defined by the claims, and nothing in this section should be taken as a limitation on those claims.

By way of introduction, the embodiments described below provide a MTP-capable USB device and methods for use therewith. The USB device is provided with circuitry operative to communicate with a host device using a media transfer protocol and receive a command from the host device to play content stored in the memory of the USB device. In one embodiment, the USB device is free of a user input device for providing a command to the circuitry to play content stored in the memory. In another embodiment, the USB device is free of a display device. In yet another embodiment, the USB device comprises a housing comprising a USB Flash drive form factor. Other embodiments are provided, and each of these embodiments can be used alone or in combination with one another.

The embodiments will now be described with reference to the attached drawings.

### BRIEF DESCRIPTION OF THE DRAWINGS

FIG. 1 is an illustration of a USB device of an embodiment.

FIG. 2 is a flow chart illustrating a method for using a USB device of an embodiment.

### DETAILED DESCRIPTION OF THE PRESENTLY PREFERRED EMBODIMENTS

By way of introduction, the inventors have recognized that when a portable digital media player is connected to a USB port of a PlaysFromDevice™ product, the navigation and output devices of the portable digital media player are not used, as they are superceded by those of the PlaysFromDevice™ product. For example, a PlaysFromDevice™ car stereo's buttons and speakers—not those of the portable digital media player—would be used to select and play a song. Accordingly, a simpler and smaller USB device (e.g., one without a user interface and/or output device), such as a USB Flash drive, can be used to transport digital content to the PlaysFromDevice™ product. Unfortunately, DRM-protected content is transferred using a media transfer protocol (MTP), while standard USB Flash drives use a mass storage class (MSC) format and do not support MTP and DRM. In general, MSC presents a storage device as an ordinary disk drive, while MTP maintains a database index to all files and objects stored on the storage device to allow fast navigation and access to many properties of the digital content stored therein (e.g., album, artist, and genre).

The following embodiments are directed to MTP-capable USB devices that can be used to address the issues noted above. In general, the USB devices of these embodiments communicate with a host device using MTP and receive a command from the host device to play content stored in the USB device. In one embodiment, the USB device is free of a user input device for providing a command to play content stored in the device. Since a user input device on a PlaysFromDevice™ product provides such a command, a user input device on the USB device itself is not needed. Similarly, in another embodiment, the USB device is free of a display device. Because a user does not use a user input device on the USB device to select digital content, a display device used to assist in such navigation is not needed. The USB device also does not contain a speaker or headphone jack to play the content. It should be noted that because a user input device, display device, and speaker are not needed on the USB device (since such functionality can be provided on the PlaysFromDevice™ product), in one embodiment, the USB device can be as simple as a USB Flash (thumb) drive. However, the USB device of these embodiments can take any size, and the claims should not be limited to a USB Flash drive unless that term is explicitly recited therein.

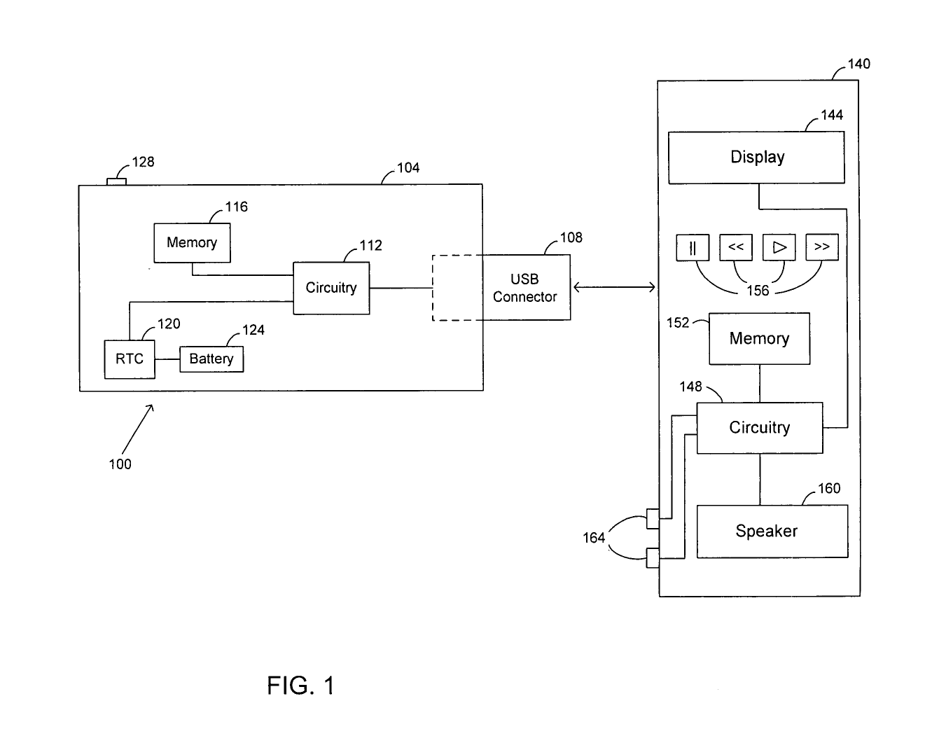

Turning now to the drawings, FIG. 1 is an illustration of a USB device 100 of an embodiment. The USB device 100 can take any shape and form and, in one embodiment, takes the form of a USB Flash (“thumb”) drive. For example, the USB device 100 can have a housing 104 having a length less than about 80 mm and a width less than about 30 mm. Of course, other form factors can be used. For example, the USB device 100 could have a larger form factor, such as a fully-functional digital media player. Also, although the housing 104 is shown in FIG. 1 as being of a rectangular shape, any geometrical shape can be used. As shown in FIG. 1, the USB device 100 comprises a USB connector 108, circuitry 112, a memory 116, a real-time clock (“RTC”) 120 powered by a battery 124, and a switch 128 to switch between MSC and MTP modes of operation. Fewer, more, or different components may be provided. For example, the USB device 100 may not include the switch 128. Other components of the device 100 are not shown in FIG. 1 to simplify the drawing. Also, it should be noted that while the components in FIG. 1 are shown as separate from one another, one or more of these components can be combined. A discussion of these components will now be presented, followed by a discussion of their use in operation.

The USB connector 108 is a connector that allows communication with another device using USB commands (e.g., MSC and/or MTP). Although the USB connector 108 is show as a protruding plug in FIG. 1, it should be understood that the USB connector 108 can take other forms. For example, the connector 108 can be positioned inside the housing 104 and can be moveable or retractable. Furthermore, a removable cap or top may join with or contact the housing 104 to cover the USB connector 108. Also, instead of taking the form of a plug, the USB connector 108 can take the form of a female receptacle. Also, while the USB connector 108 can be designed to directly physically mate with a mating connector, a wire or cable can be used to make the connection.

The memory 116 can take any suitable form, such as, but not limited to, non-volatile and/or volatile solid state, magnetic, and optical memories with one-time, few-time, or many-time programmable memory cells. In a presently preferred embodiment, the memory 116 takes the form of Flash memory. The memory 116 is operative to store digital content (sometimes referred to herein as digital media). Digital content can take any suitable form, such as, but not limited to, audio (e.g., a song, spoken word, a podcast, one or a series of sounds, etc.), video (with or without accompanying audio) (e.g., a movie, an episode of a TV show, a news program, etc.), still or moving images (e.g., a photograph, a computer-generated display, etc.), text (with or without graphics) (e.g., an article, a text file, etc.), and a hybrid multi-media presentation of two or more of these forms. For simplicity, in illustrating the following embodiments, the digital content will take the form of digital audio (e.g., songs). The memory 116 can store additional information. For example, in one embodiment, the memory 116 also stores a numeric or alpha-numeric serial number of the USB device 110, which can be used by a digital content subscription service to limit the number of devices per user.

Because the USB device 100 communicates using MTP, the USB device 100 may include a MTP database, which stores metadata associated with digital content stored in the memory 116. Metadata refers to information about digital content. Examples of metadata can include, but are not limited to, information that allows a user to make a selection of the digital content for playback (e.g., song name, album name, artist name, etc.), information that allows a host device to know how to decode and play the digital content (e.g., bit rate, encode method (e.g., MP3 or WMA), order of songs on an album to properly sequence playback of the songs, etc.), and associated information about the digital content (e.g., album art, duration of a song/album, etc.). Metadata can be stored in the file of the digital content itself (e.g., in a header block of the file) or can be stored in a separate location (e.g., a jpeg image of album art can be stored separately from the digital content file). Although some forms of metadata can be the same as information from a file system (e.g., the title of a song can be the same as the actual file name), in general, metadata is usually information other than what is typically gleaned from file system information (e.g., file name and file size).

The circuitry 112 is used to perform various functions as described below. As used herein, “circuitry” can include one or more components and be a pure hardware implementation and/or a combined hardware/software (or firmware) implementation. Accordingly, “circuitry” can take the form of one or more of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. In a presently preferred embodiment, the circuitry 112 includes an ASIC, such as an Orpheus 3 ASIC. The Orpheus 3 may contain the necessary CPU and internal RAM (e.g., about 300K) to run a MTP stack. Alternatively, other ASICs or components may be used.

It should be noted that the USB device 100 in this embodiment does not have a user input device for selecting content stored in the memory 116 of the device 100, nor does it have a display device to facilitate such selection. The USB device 100 in this embodiment also does not have an output device (e.g., a speaker or a headphone jack) for playing back digital content stored in the memory 116 of the USB device 100. Accordingly, the USB device 100 is merely used to transport digital content to a host device for playback.

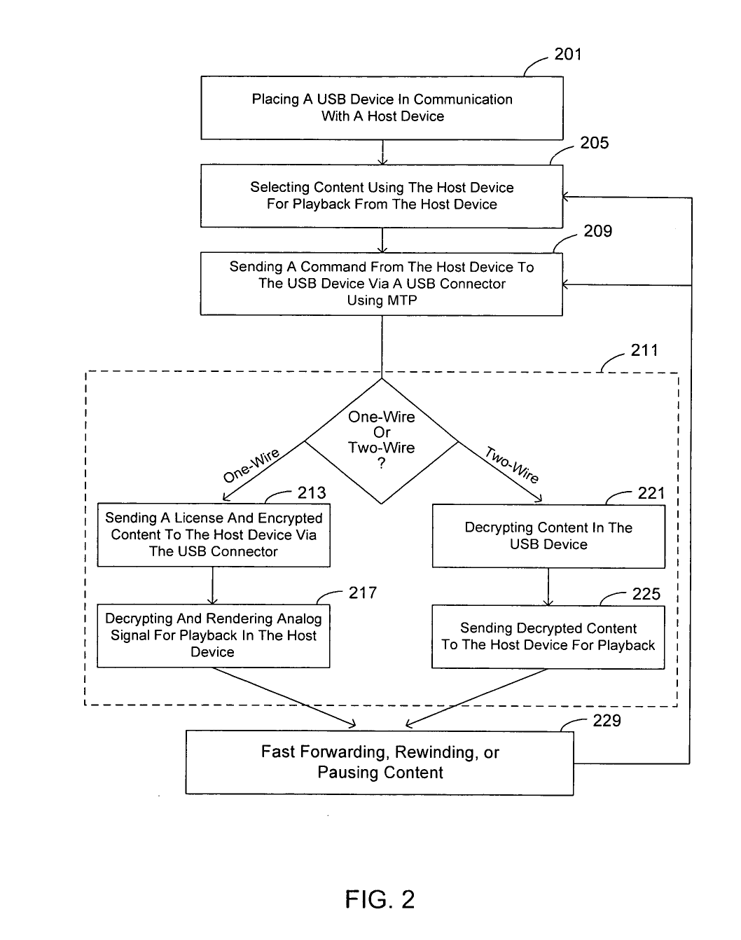

As shown in FIG. 1, the USB device 100 is in communication with a host device 140 through a USB connector (not shown) on the host device 140. As used herein, the phrase “in communication with” means directly in communication with or indirectly in communication with through one or more components, which may or may not be shown or described herein. In this embodiment, the host device 140 includes a display 144, one or more selection buttons 156, circuitry 148, a memory 152, a speaker 160, and/or audio/video jacks 164. Fewer, more, or different components may be provided. A host device 140 can take any suitable form, such as, but not limited to, a vehicle stereo, a computer, or a gaming system. In a presently preferred embodiment, the host device 140 is a PlaysFromDevice™ product, such as a car stereo or a game box (e.g., Xbox™). The host device 140 is operative to select and render digital content stored in the USB device 100, as described below and illustrated in the flow chart of FIG. 2.

In operation, after the user connects the USB device 100 to the host device 140 (act 201, see FIG. 2), the host device 140 communicates with the USB device 100 via the USB connector 108 using MTP. The user uses the buttons 156 on the host device 140 to select digital content stored in the memory 116 of the USB device 100 for playback on the host device 140 (act 205). For example, if the host device 140 is a PlaysFromDevice™ capable host device, the host device 140 can obtain knowledge of the digital content stored in the memory 116 of the USB device 100 through an MTP database also stored in the memory 116 of the USB device 100. When the user selects content using the host device 140, the host device 140 sends a command to the circuitry 112 in the USB device 100 to play the selected content stored in the memory 116 (act 209), and the circuitry 112 presents the content in some form to the host device 140 for playback (act 211). The actual operation of the circuitry 112 depends on many factors, such as whether the content is encrypted and whether the USB device 100 operates in a “one wire” or “two wire” implementation.

In general, digital content protected by DRM is typically encrypted and requires a license, e.g., one provided in accordance with Janus™ DRM. A license is the right or permission to use the content. Without a valid license, the associated content cannot be played. When the digital media files are stored in the USB device 100 in MTP mode, the circuitry 112, using an MTP stack, stores the digital content in one file and the associated license in another file in the memory 116 according to MTP protocols. MTP considers objects to be entities with properties, and operations can be performed on the objects. Mass storage class (“MSC”), on the other hand, presents a storage volume, such as a disk drive. MSC does not allow correlation between one object to another. MSC is a protocol that provides a mechanism to read out data or data sectors on a drive.

In a one-wire implementation, based on the command from the host device 140, the circuitry 112 sends both the encrypted content and a license for the encrypted content to the host device 140 (act 213), and the host device 140 decrypts the encrypted content for playback and license validation (act 217). The host device 140 may also decode or decompress the content and render analog signals for audio or video output. Alternatively, if the content is not encrypted, the host device 140 merely decodes or decompresses the content (and validate the license). In a two-wire implementation, based on the command from the host device 140, the circuitry 112 decrypts the encrypted content, validates the license, and sends the decrypted content to the host device 140 for playback (acts 221, 225). The battery-powered RTC 120 can be used to provide time to the circuitry 112 to validate the license, if time-based. (A serial number stored in the memory 116 can also be used in the license validation process.) The circuitry 112 may also decode or decompress the content. Alternatively, if the content is not encrypted, the USB device 100 can merely decode or decompress the content, validate the license, and send the resulting content to the host device 140 for playback. During the playback, controls on the host device 140 can be used to control operation of the playback (e.g., fast forwarding, rewinding, or pausing content) (act 229).

There are several alternatives that can be used with these embodiments. For example, instead of a host device being a product such as a car stereo of game box, the host device can be a digital media player (a “host player”). This type of host would be a simple, portable device that includes “USB OTG (on the go)” support for a thumb drive, in addition to a USB connection for a host computer. The host player would pass thru the control to the MTP storage module when connected to another computer. When operating in standalone mode, the host player initiates a secure session with the USB device and retrieves content in a manner similar to the car stereo system host. In one embodiment, no Flash storage resides on the host player, and only the decoder, user interface, keyboard, and display firmware may be needed. The host player can optionally boot its device firmware from the USB device, eliminating NAND storage from the host player. The host player can include a rechargeable battery, so it can function on its own and power the MTP USB device.

It is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

What is claimed is:

1. A universal serial bus (“USB”) device comprising:
a USB connector;
a memory; and
circuitry in communication with the USB connector and the memory, the circuitry operative to:
communicate with a host device via the USB connector using a media transfer protocol; and
receive a command from the host device via the USB connector to play content stored in the memory;
wherein the USB device is free of a user input device for providing a command to the circuitry to play content stored in the memory.

2. The USB device of claim 1, wherein the USB device is also free of a display device.

3. The USB device of claim 1 further comprising a housing supporting the USB connector, the memory, and the circuitry, wherein the housing comprises a USB Flash drive form factor.

4. The USB device of claim 1 further comprising a housing supporting the USB connector, the memory, and the circuitry, wherein the housing comprises a length less than about 80 mm.

5. The USB device of claim 1 further comprising a housing supporting the USB connector, the memory, and the circuitry, wherein the housing comprises a width less than about 30 mm.

6. The USB device of claim 1 further comprising:
a switch in communication with the circuitry and operative to activate the USB device into a mass storage class mode.

7. The USB device of claim 1 further comprising:
a clock in communication with the circuitry, wherein the circuitry is operative to use time from the clock to validate a time-based license for the content.

8. The USB device of claim 7 further comprising:
a battery in communication with the clock.

9. The USB device of claim 1, wherein the memory comprises a Flash memory.

10. The USB device of claim 1, wherein the content is encrypted, and wherein the circuitry is further operative to, in response to receiving the command from the host device to play the content stored in the memory:
send a license for the content to the host device; and
send the content to the host device for decryption and playback.

11. The USB device of claim 1, wherein the content is encrypted, and wherein the circuitry is further operative to decrypt the content in response to receiving the command from the host device to play the content stored in the memory.

12. The USB device of claim 1, wherein the memory is further operative to store a serial number.

13. The USB device of claim 1, wherein the content stored in the memory comprises audio content.

14. The USB device of claim 1, wherein the content stored in the memory comprises video content.

15. A universal serial bus (“USB”) device comprising:
a USB connector;
a memory;
circuitry in communication with the USB connector and the memory, the circuitry operative to:
communicate with a host device via the USB connector using a media transfer protocol; and
receive a command from the host device via the USB connector to play content stored in the memory; and
a housing supporting the USB connector, the memory, and the circuitry, wherein the housing comprises a USB Flash drive form factor.

16. The USB device of claim 15, wherein the housing comprises a length less than about 80 mm.

17. The USB device of claim 15, wherein the housing comprises a width less than about 30 mm.

18. The USB device of claim 15, wherein the USB device is free of a user input device for providing a command to the circuitry to play content stored in the memory and is also free of a display device.

19. The USB device of claim 15, wherein the content is encrypted, and wherein the circuitry is further operative to, in response to receiving the command from the host device to play the content stored in the memory:
send a license for the content to the host device; and
send the content to the host device for decryption and playback.

20. The USB device of claim 15, wherein the content is encrypted, and wherein the circuitry is further operative to decrypt the content in response to receiving the command from the host device to play the content stored in the memory.

21. A universal serial bus (“USB”) device comprising:
a USB connector;
a memory;
circuitry in communication with the USB connector and the memory, the circuitry operative to:
communicate with a host device via the USB connector using a media transfer protocol; and
receive a command from the host device via the USB connector to play content stored in the memory; and
a housing supporting the USB connector, the memory, and the circuitry, wherein the housing comprises a USB Flash drive form factor;
wherein the USB device is free of a user input device for providing a command to the circuitry to play content stored in the memory and is also free of a display device.

22. The USB device of claim 21, wherein the housing comprises a length less than about 80 mm.

23. The USB device of claim 21, wherein the housing comprises a width less than about 30 mm.

24. The USB device of claim 21, wherein the content is encrypted, and wherein the circuitry is further operative to, in response to receiving the command from the host device to play the content stored in the memory:
send a license for the content to the host device; and
send the content to the host device for decryption and playback.

25. The USB device of claim 21, wherein the content is encrypted, and wherein the circuitry is further operative to decrypt the content in response to receiving the command from the host device to play the content stored in the memory.

26. A method for using a universal serial bus (“USB”) device, the method comprising:
with a universal serial bus (“USB”) device comprising a USB connector and memory:
communicating with a host device via the USB connector using a media transfer protocol; and
receiving a command from the host device via the USB connector to play content stored in the memory
wherein the USB device is free of a user input device for providing a command to play content stored in the memory.

27. The method of claim 26, wherein the USB device is also free of a display device.

28. The method of claim 26, wherein the USB device comprises a housing comprising a USB Flash drive form factor.

29. The method of claim 26, wherein the USB device comprises a housing comprising a length less than about 80 mm.

30. The method of claim 26, wherein the USB device comprises a housing comprising a width less than about 30 mm.

31. The method of claim 26, wherein the USB device further comprises a switch to activate the USB device into a mass storage class mode.

32. The method of claim 26, wherein the USB device further comprises a clock used to validate a time-based license of the content.

33. The method of claim 32, wherein the USB device further comprises a battery in communication with the clock.

34. The method of claim 26, wherein the memory comprises a Flash memory.

35. The method of claim 26, wherein the content is encrypted, and wherein the method further comprises, in response to receiving the command from the host device to play the content stored in the memory:
sending a license for the content to the host device; and
sending the content to the host device for decryption and playback.

36. The method of claim 26, wherein the content is encrypted, and wherein the method further comprises:
decrypting the content in response to receiving the command from the host device to play the content stored in the memory.

37. The method of claim 26, wherein the memory is further operative to store a serial number.

38. The method of claim 26, wherein the content stored in the memory comprises audio content.

39. The method of claim 26, wherein the content stored in the memory comprises video content.

40. A method for using a universal serial bus (“USB”) device, the method comprising:
with a universal serial bus (“USB”) device comprising a USB connector and memory:
communicating with a host device via the USB connector using a media transfer protocol; and
receiving a command from the host device via the USB connector to play content stored in the memory;
wherein the USB device comprises a housing comprising a USB Flash drive form factor.

41. The method of claim 40, wherein the housing comprises a length less than about 80 mm.

42. The method of claim 40, wherein the housing comprises a width less than about 30 mm.

43. The method of claim 40, wherein the USB device is free of a user input device for providing a command to play content stored in the memory and is also free of a display device.

44. The method of claim 40, wherein the content is encrypted, and wherein the method further comprises, in response to receiving the command from the host device to play the content stored in the memory:
sending a license for the content to the host device; and
sending the content to the host device for decryption and playback.

45. The method of claim 40, wherein the content is encrypted, and wherein the method further comprising:
decrypting the content in response to receiving the command from the host device to play the content stored in the memory.

46. A method for using a universal serial bus (“USB”) device, the method comprising:
with a universal serial bus (“USB”) device comprising a USB connector and memory:
communicating with a host device via the USB connector using a media transfer protocol; and
receiving a command from the host device via the USB connector to play content stored in the memory; and
wherein the USB device comprises a housing comprising a USB Flash drive form factor, and wherein the USB device is free of a user input device for providing a command to the circuitry to play content stored in the memory and is also free of a display device.

47. The method of claim 46, wherein the housing comprises a length less than about 80 mm.

48. The method of claim 46, wherein the housing comprises a width less than about 30 mm.

49. The method of claim 46, wherein the content is encrypted, and wherein the method further comprising, in response to receiving the command from the host device to play the content stored in the memory:
sending a license for the content to the host device; and
sending the content to the host device for decryption and playback.

50. The method of claim 46, wherein the content is encrypted, and wherein the method further comprises:
decrypting the content in response to receiving the command from the host device to play the content stored in the memory.
